(19) United States
(12) Patent Application Publication
(10) Pub. No.: US 2002/0097772 A1
(43) Pub. Date: Jul. 25, 2002

(54) Stabilized optical pump laser

(76) Inventors: William Crossley Dautremont-Smith, Orefield, PA (US); Sun-Yuan Huang, Fremont, CA (US); Kishore K. Kamath, Whitehall Township, PA (US); Carl E. Soccolich, Raritan Township, NJ (US)

Correspondence Address: Wendy W. Koba, P.O. Box 556, Springtown, PA, 18081-0556, US

(21) Appl. No.: 09/767,079

(22) Filed: Jan. 22, 2001

(51) Int. Cl. H01S 3/13; H01S 3/08

(52) U.S. Cl. 372/102; 372/92

(57) ABSTRACT

An optical laser module exhibits stabilized output power over a range of input bias current and temperatures by utilizing an external Bragg grating with an essentially flat response over the grating bandwidth. The flat response is provided by using a combination of separate external gratings, the gratings exhibit different center wavelengths, with a center wavelength separation of 0.5 nm considered to be optimal.

### TECHNICAL FIELD

The present invention relates to a stabilized optical pump laser and, more particularly, to using a combination of grating structures within an external fiber grating to provide output wavelength stabilization over a range of input currents and operating temperatures.

### BACKGROUND OF THE INVENTION

Most advanced optical fiber communication systems now in place, as well as contemplated for use in the future, utilize doped fiber amplifiers to increase the span length between regenerators. The most common doped fiber amplifier is the erbium-doped fiber amplifier (EDFA), which utilizes a “pump laser” at a predetermined wavelength to mix with an optical signal passing through the erbium-doped medium to provide amplification to the optical signal. In particular, the use of a pump laser operating at a wavelength of 980 nm has become increasingly popular, due to its high electrical-to-optical conversion efficiency and the resultant low noise figure of the optical amplifier. The pump laser module typically consists of a pump laser device, coupling optics and an external fiber grating. The gain bandwidth of this amplifier is sufficient to permit simultaneous amplification of multiple channels and, therefore, lends impetus to wavelength division multiplexing (WDM) systems.

Recently, “dense” WDM systems (DWDM) have been developed, characterized by an extremely close spacing between a large number of communication channels supported by the system. As a result of the channel spacing restriction in DWDM, gain flatness of an optical amplifier over the signal band is very important for each channel. Therefore, a narrow wavelength pumping for the 980 nm pump laser sources is required. Additionally, there are situations that require the pump power to be adjusted to maintain a constant output signal, such as when switching from a large number of channels in one application to a smaller number of channels in another application of the same pump module. For undersea and un-cooled applications, the pump lasers must also be capable of working over a specified temperature range. Thus, in most contemplated system applications, a pump laser using an external grating is the best solution. U.S. Pat. No. 5,563,732 issued to Erdogan et al. on Oct. 8, 1996 discloses one such prior art arrangement including an external grating with a pump laser.

Although the use of an external grating has increased the stability of pump lasers, it has been observed that under certain laser current and temperature conditions, the optical spectrum of such a laser module can become unstable (in the time scale of a few seconds to a few minutes). During this period of instability, the monitor current will also fluctuate, where this spectral instability can affect the optical power stability through the narrow-band pump combiner. The monitor current fluctuations can also cause the optical power to become unstable under a constant monitor current feedback. It has also been observed that there exist undulations for both the front fiber output power and the rear monitor current as the laser driving current increases, particularly when the increases are relatively small (on the order of a 1 mA step size).

Thus, a need remains in the art for a stable optical pump module that is capable of removing the undulation in the drive current as described above, while also providing extremely stable operating characteristics (in terms of optical output power, for example) for each channel in the optical system, particularly when used in a DWDM system.

### SUMMARY OF THE INVENTION

The need remaining in the prior art is addressed by the present invention, which relates to a stabilized optical pump laser and, more particularly, to using a combination of grating structures within an external fiber grating to provide output wavelength stabilization over a range of input currents and operating temperatures.

In accordance with the present invention, an external grating is formed that exhibits a “flat-top” profile, thus ensuring that there are always two equal Fabry-Perot (FP) modes over the laser's operational current and temperature ranges. The presence of the two FP modes greatly reduces the coherence length and reduces the phase effect that causes the spectral and power fluctuations and undulations.

In one embodiment of the present invention, a pair of gratings can be used to form the “flat-top” profile of the grating structure, where the gratings are offset in center wavelength by their reflectivity bandpass (for example, 0.5 nm).

Other and further embodiments of the present invention will become apparent during the course of the following discussion and by reference to the accompanying drawings.

### BRIEF DESCRIPTION OF THE DRAWINGS

Referring to the drawings:

FIG. 1 contains a diagram of the transmission spectrum for a conventional fiber grating;

FIG. 2 illustrates a “flat top” profile of a fiber grating formed in accordance with the teaching of the present invention;

FIG. 3 is a diagram of an exemplary arrangement useful for testing the performance of the flat top fiber grating of the present invention;

FIG. 4 contains plots of the backface monitor current, Ibd, of a conventional pump laser with an external grating, plotted for three different input currents;

FIG. 5 contains plots of the backface monitor current, Ibd, of a pump laser with a flat top external grating, formed in accordance with the present invention with a center wavelength separation of 0.38 nm between the fiber gratings, for three different input currents;

FIG. 6 contains plots of the backface monitor current, Ibd, of a pump laser with a flat top external grating, formed in accordance with the present invention with a wavelength separation of 0.50 nm between the fiber gratings, for the same three input currents;

FIG. 7 contains plots of the backface monitor current, Ibd, of a pump laser with a flat top external grating, formed in accordance with the present invention with a wavelength of 0.59 nm between the fiber gratings, for the same three input currents;

FIG. 8 illustrates the optical spectra with the maximum-hold, minimum-hold and active traces for a conventional pump laser/grating combination;

FIG. 9 illustrates the optical spectra with maximum-hold, minimum-hold and active traces for a pump laser/“flat top” grating arrangement of the present invention;

FIG. 10 contains a graph of both optical power and monitor current as a function of laser drive current for a conventional fiber/grating combination; and

FIG. 11 contains a graph of optical power and monitor current as a function of laser drive current for a fiber/“flat top” grating arrangement formed in accordance with the present invention.

### DETAILED DESCRIPTION

FIG. 1 illustrates the transmission spectrum for a conventional, commercially available, fiber grating. The grating associated with this transmission spectrum exhibits a center wavelength of 973.89 mn, measured at a temperature of 23° C. The reflectance of the grating is defined by subtracting the transmittance value at each wavelength from the value of “1”. The peak reflectivity ranges from 1% to 10%, and the full-width half-maximum (FWHM) spectral width ranges from 0.4 nm to 0.6 nm As shown, the spectrum exhibits a symmetric sinc (or Gaussian) profile. A typical grating such as that of FIG. 1 exhibits a single peak, where this peak has been found to be the direct cause of the undulations on the current scans for both the front fiber power and the back monitor current. Additionally, the presence of this single peak is an indirect cause of both power and spectral fluctuations.

In particular, when the laser junction temperature changes (which can be due to either a change of the laser submount temperature or change of the laser drive current) the FP modes of the laser cavity can move up or down the grating profile. As one of the FP modes coincides with the peak of the grating reflectivity, there will be an enhancement in the reflection properties of the grating. This enhancement will, in turn, increase the backface monitor current and slightly decrease the optical output power from the front facet. As the FP mode moves away from the grating peak, the next FP mode moves toward the grating peak. When the two FP modes are equidistant from the grating peak (one ahead of the peak and one behind the peak), there will be a reduction in the reflection properties of the grating. The reduction in reflection will decrease the backface monitor current and slightly increase the optical power output from the front facet. The magnitude of change for the backface monitor is much greater than that of the front facet power, due to the asymmetrical coating of the laser facets. The period of this undulation decreases as the laser drive current increases, since the joule heating is proportional to the square of the current.

Both the front and rear power fluctuations occur when one of the FP modes coincides with the peak of the grating. The optical spectrum in this situation can either become a pure single mode, or a multi-mode, depending on the phase difference between the returned wave from the fiber grating and the laser cavity wave. If the optical path between the laser and the fiber grating is such that the phase difference is 0°, there will be enhancement on the resulting wave and its spectrum becomes pure single mode with a long coherence length. If the phase difference is 180°, there will be a reduction in the gain for the main mode and the spectrum will become multi-mode with a short coherence length. In particular, a quarter wavelength shift in the optical path will be sufficient to cause the 180° change. This small shift can easily be caused by temperature fluctuations or by stress relaxation in the fiber grating.

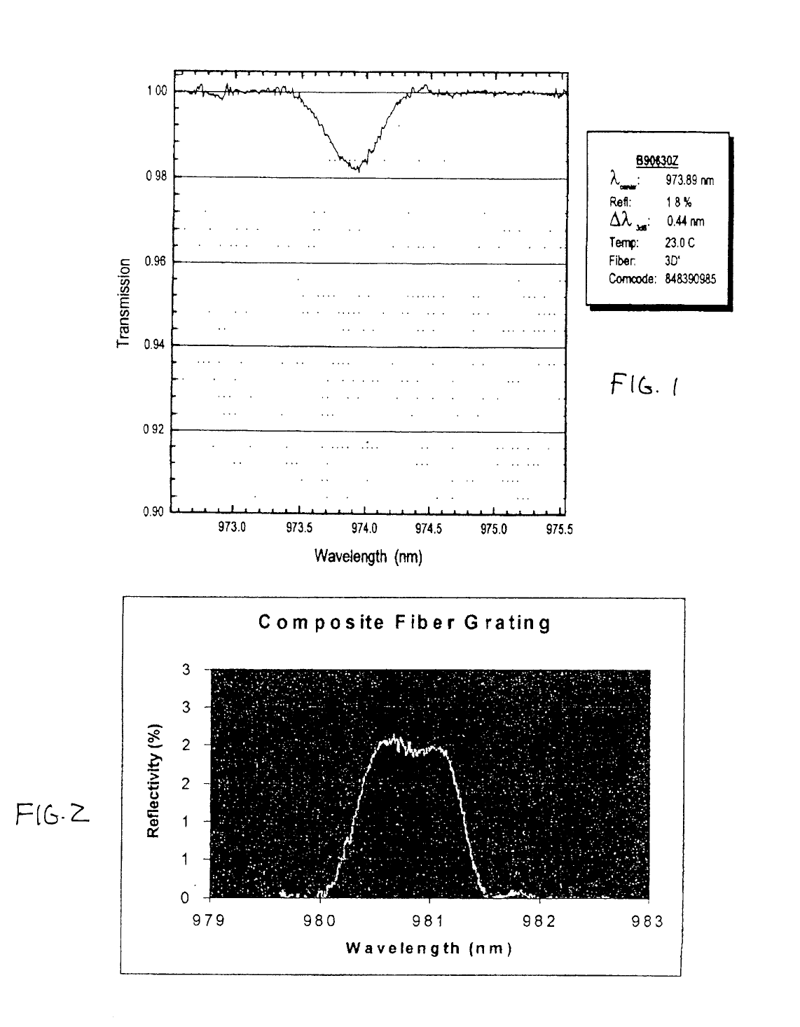

These and many other problems are overcome with the utilization of a “flat top” optical fiber grating, formed in accordance with the present invention. FIG. 2 illustrates the profile of one such exemplary grating, in this particular example comprising two regular Gaussian-shaped fiber gratings with a predetermined wavelength offset defined therebetween. In principle, the utilization of a flat top grating avoids the coincidence of the FP mode with a peak in the grating, as discussed above in association with the prior art illustration of FIG. 1. Particularly, the flat top fiber grating ensures that there will always be two equal strength FP modes in the grating profile over the laser operational current and temperature. The two FP modes greatly reduce the coherence length and, in turn, reduce the phase effect that causes the spectral and power fluctuations, as well as the undulations with the scans of the laser drive current and/or temperature.

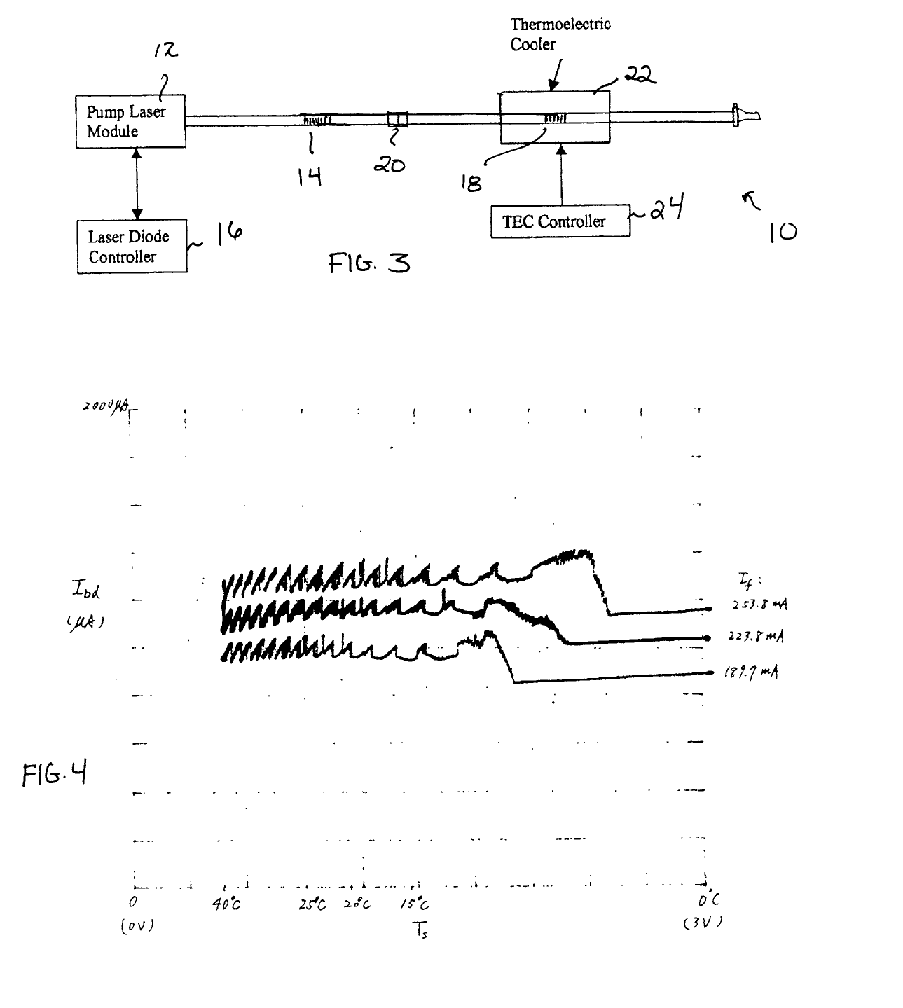

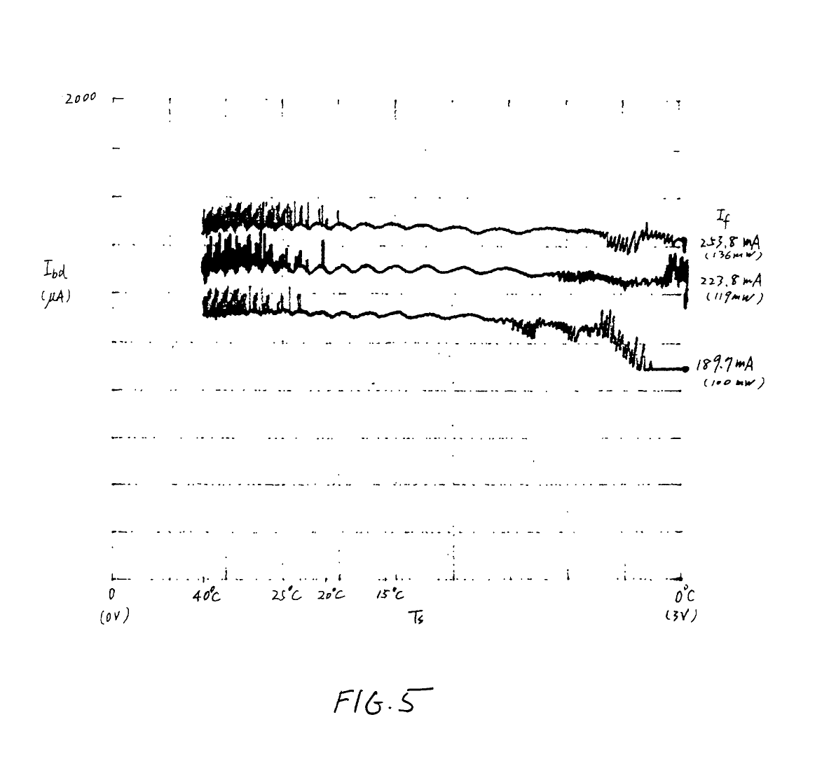

An arrangement 10 for testing the properties of the flat top fiber grating of the present invention is illustrated in FIG. 3. As shown, a 980 nm pump laser module 12 is coupled at its output to a first fiber grating 14. In one embodiment, first fiber grating 14 exhibits a center wavelength of 973.89 nm at a temperature of 23° C., a grating peak reflectivity of 1.8%, and a FWHM spectral width of 0.44 nm. FIG. 4 is a plot of the backface monitor current, Ibd, of pump laser module 12 as a function of laser submount temperature (Ts) for three different bias currents, the bias currents supplied by a laser diode controller 16. “Instability” is defined as the peak-to-peak fluctuations in backface monitor current divided by the average current. Referring to FIG. 4, between 15° C. and 23° C., the instability was measured to be 8% at 189.7 mA. The corresponding instability for the front facet optical power was less than 0.5%. In this situation, therefore, a measurement of the backface monitor current is a better indication of temperature stability/instability. As shown on the plots of FIG. 4, there are undulations in the traces for each bias current, having about the same magnitude as the instability.

In accordance with the present invention, an increase in the output power stability is achieved by including in the laser system a second fiber grating 18 that exhibits a slightly different center wavelength than first fiber grating 14. Second fiber grating 18, in the specific embodiment as shown in FIG. 3, is coupled to first grating 14 using, for example, a fusion splice 20. Alternatively, first grating 14 and second grating 18 may be formed as interleaved gratings within the same physical location. When the gratings are “interleaved” one set of grating lines are alternated with the grating lines of the other. In one embodiment of the present invention, second fiber grating 18 is formed to exhibit a center wavelength of 974.27 nm (at 23° C.), a grating peak reflectivity of 2.1 % and a FWHM spectral width of 0.5 nm. At this temperature, then, the wavelength offset between the two gratings is 0.38 nm. For the purposes of experimentation and evaluating the performance of a flat top grating as a function of the separation between center wavelengths of the two gratings, second fiber grating 18 was coupled to a thermoelectric cooler (TEC) 22, as shown in FIG. 3, since changes in temperature of a fiber grating will cause its center wavelength to shift. For this exemplary arrangement, the “tuning” rate was found to be 6 pm/° C.

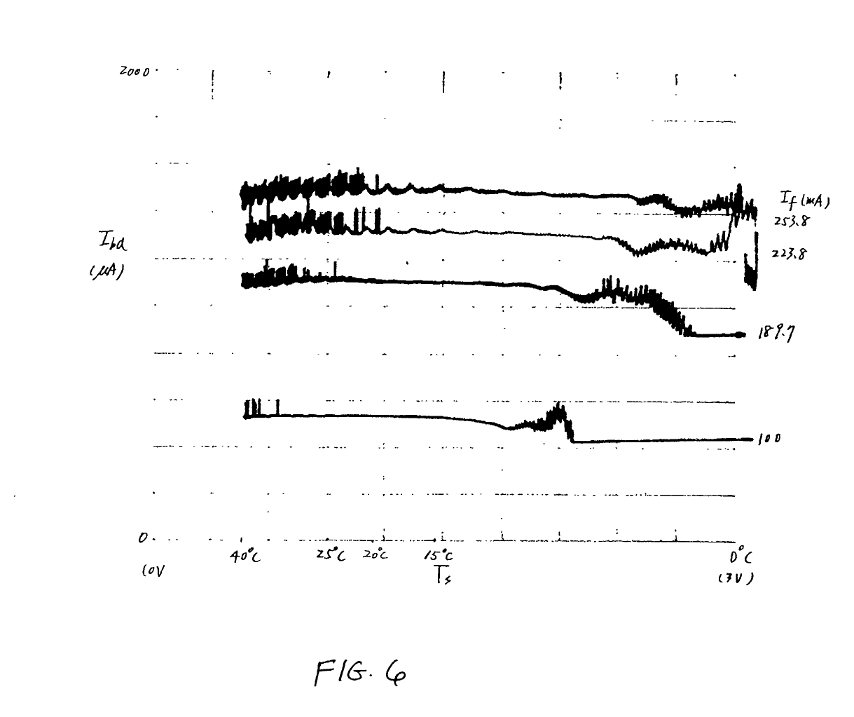

FIG. 5 is a graph of Ibd as a function of temperature (Ts) for three different bias currents—189.7 mA, 223.8 mA, and 283.8 mA, all measured with second fiber grating 18 held at a temperature of 23° C. (thus exhibiting a wavelength offset of 0.38 nm). Between the temperatures of 15° C. and 23° C., the instability of the laser's performance is only approximately 1 %, a significant reduction from the 8% value associated with the prior art arrangement (as shown in FIG. 4). Similar behavior is observed for the remaining bias current values. The undulation of the Ibd curve is also reduced, in this case to a level of approximately 1.8%.

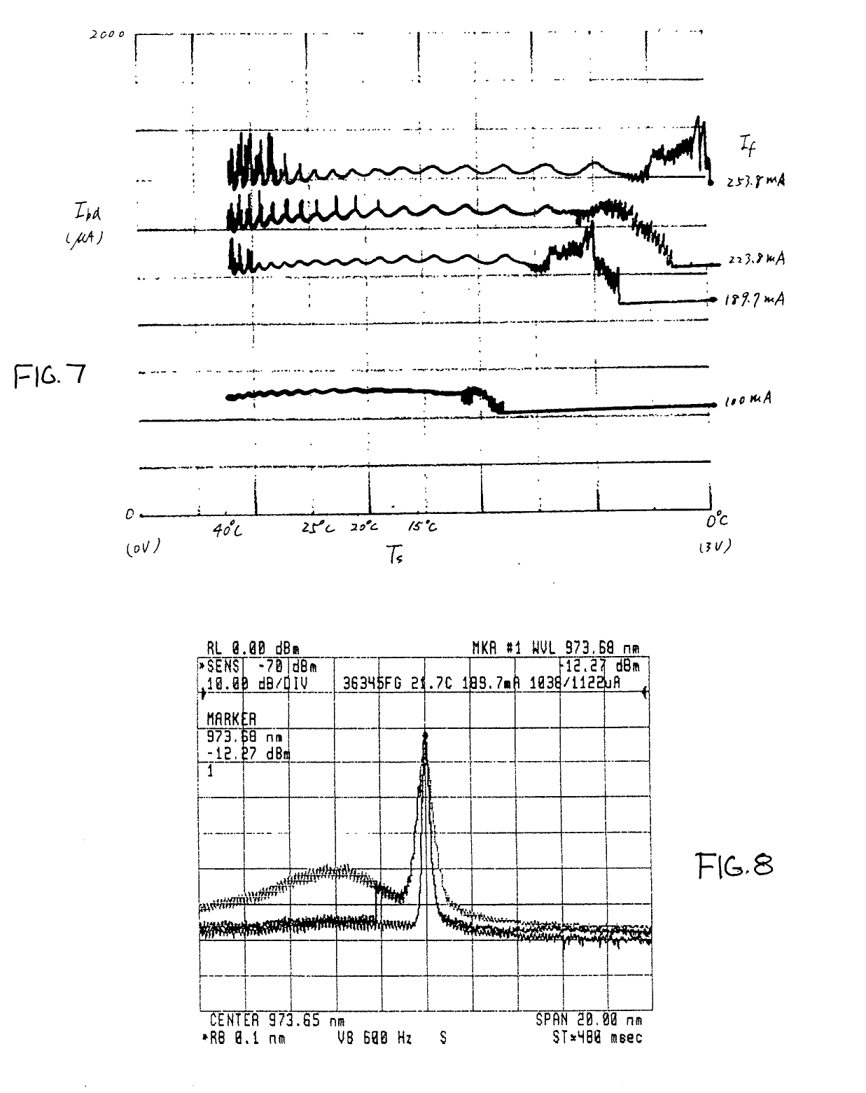

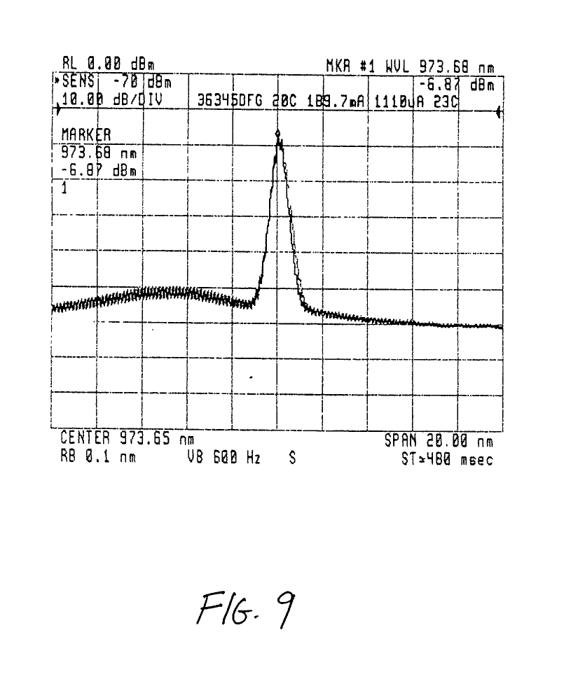

The wavelength offset between first fiber grating 14 and second fiber grating 18 can be increased to a value of approximately 0.5 nm by increasing the local temperature of second fiber grating 18 (via a TEC controller 24) to a value of 45° C. (this increase in temperature shifting the center wavelength of second fiber grating 18 to a value of 974.39 nm). The resulting plots of Ibd as a function of laser submount temperature (Ts) for this arrangement (at the same three bias currents) is shown in FIG. 6. As can be seen, both the instability and undulation are essentially 0% over the laser submount temperature range of interest (15-23° C.). An additional increase in the local temperature of second fiber grating 18 to a value of 60° C. yields a shift in center wavelength to a value of 974.48 nm—a center wavelength separation of 0.59 nm. FIG. 7 contains plots of Ibd vs. Ts for this wavelength separation. As shown, the instability is reduced to approximately 0%, but the undulation has returned to approximately the 1.8% value. Therefore, for this particular arrangement of fiber and second fiber gratings 14,18, the minimum instability and undulation values occurred at a wavelength separation of 0.5 nm.

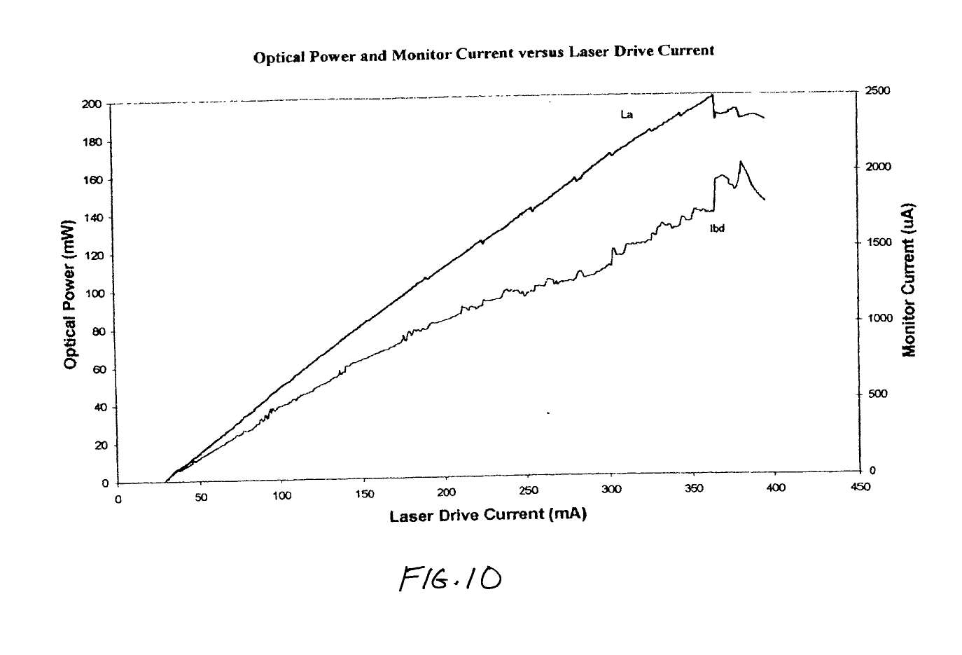

The improvement in performance associated with the flat top grating of the present invention can also be discerned from evaluating the spectral stability of the laser arrangement. FIG. 8 contains plots of the optical spectra for a conventional, prior art single fiber grating laser, illustrating maximum-hold, minimum-hold and active traces over a one minute interval. As shown, the optical output spectrum changes between the maximum-hold and minimum-hold curves. In contrast, FIG. 9 illustrates the same three curves for a laser module of the present invention, including a flat top grating as shown in FIG. 3. In this case, the three curves overlap, indicating stable optical behavior.

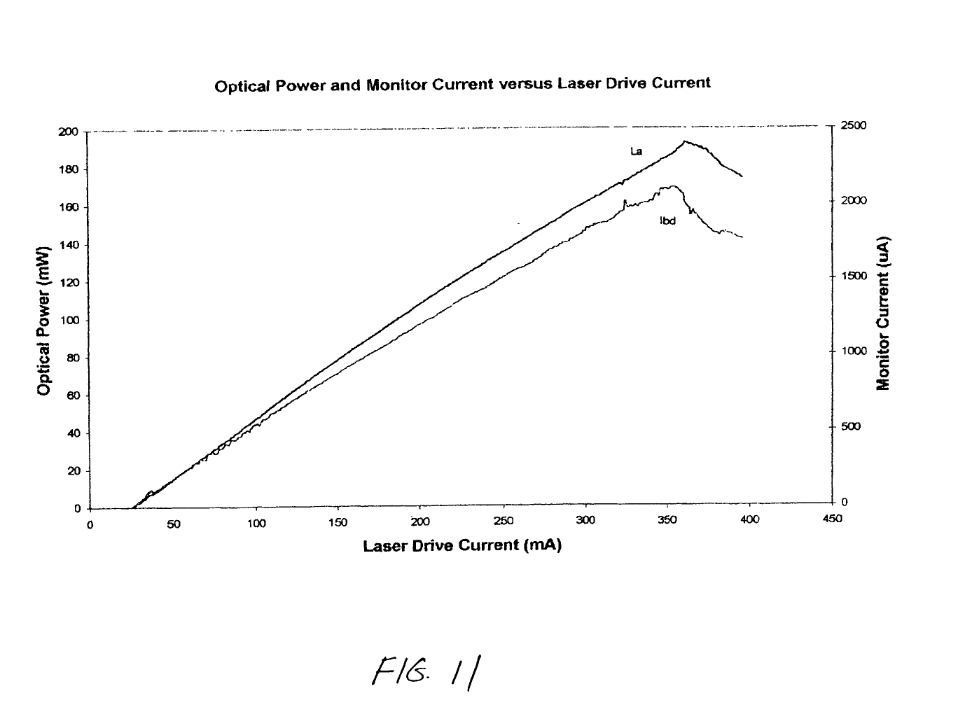

A determination of the linearity of the optical power (La) and monitor current (Ibd) as a function of laser current can also be used to determine the stability of the laser module. FIG. 10 is a graph of both optical power and monitor current for a conventional prior art laser module utilizing a single external grating. As can be seen, there are obvious steps in the La/I curve at 189.7 mA, 223.8 mA, 253.8 mA, and so on. The Ibd/I curve is extremely irregular and abnormal. FIG. 11 contains plots of the same parameters (La and Ibd) for an arrangement of the present invention, including a flat top fiber grating. In contrast to the curves of FIG. 10, the traces associated with using a flat top grating are essentially linear. Referring to the La/I curve in FIG. 11, there is no visible step(s) in the trace between laser current values of 50 mA and 300 mA. The Ibd/I curve is also extremely linear over this region.

While the present invention has been described with respect to specific examples, it will be appreciated that the inventive concept of the invention is not so limited. In general, any number of gratings may be used, as long as the center wavelengths of such gratings are separated so as to create two essentially equal Fabry-Perot (FP) modes over the laser's operational current and temperature ranges. The presence of the two FP modes greatly reduces the coherence length and reduces the phase effect that causes the spectral and power fluctuations and undulations. The present invention is also applicable to non-fiber gratings and reflectors. It should be noted that the term “external” as used herein means external to the laser cavity, and does not preclude the incorporation of reflectors on the same substrate as the laser device.

What is claimed is:

1. An optical laser module comprising
a semiconductor laser device emitting light at least at a certain wavelength; and
at least two optical gratings, external to said laser device, for reflecting the light emitted from the semiconductor laser and stabilizing the output therefrom, said at least two gratings having center wavelengths separated by a predetermined amount sufficient to form a grating structure having a uniform response over a predetermined range of operating conditions.

2. An optical laser module as defined in claim 1 wherein the at least two optical gratings comprise a pair of gratings.

3. An optical laser module as defined in claim 2 wherein the semiconductor emits light at a wavelength of approximately 980 nm and the pair of gratings exhibits a separation in center wavelength in the range of 0.38 nm-0.59 nm.

4. An optical laser module as defined in claim 3 wherein the pair of gratings exhibit a separation in center wavelength of approximately 0.5 nm.

5. An optical laser module as defined in claim 1 wherein the at least two optical gratings comprise at least two fiber gratings.

6. An optical laser module as defined in claim 5 wherein the at least two fiber gratings are disposed at different locations along a length of optical fiber.

7. An optical laser module as defined in claim 5 wherein the at least two fiber gratings overlap along a length of optical fiber.
